(19) United States
(12) Patent Application Publication
(10) Pub. No.: US 2014/0071225 A1
(43) Pub. Date: Mar. 13, 2014

(54) TRANSMISSION SYSTEM, RELAY APPARATUS AND TRANSMISSION TERMINAL

(71) Applicants: Hiroaki UCHIYAMA, Kanagawa (JP); Takahiro ASAI, Kanagawa (JP); Yoshinaga KATO, Kanagawa (JP); Akihiro MIHARA, Tokyo (JP)

(72) Inventors: Hiroaki UCHIYAMA, Kanagawa (JP); Takahiro ASAI, Kanagawa (JP); Yoshinaga KATO, Kanagawa (JP); Akihiro MIHARA, Tokyo (JP)

(21) Appl. No.: 14/024,821

(22) Filed: Sep. 12, 2013

(30) Foreign Application Priority Data
Sep. 13, 2012 (JP) 2012-201143

(51) Int. Cl. H04N 7/15

(52) U.S. Cl. CPC H04N 7/15
USPC 348/14.08

(57) ABSTRACT

A transmission system includes a transmission terminal configured to locally reproduce, transmit and receive via a network, video and audio; a relay apparatus configured to distribute the video data and the audio data transmitted from the transmission terminal to other transmission terminals or the transmission terminal that is a transmission source; and a transmission control apparatus configured to control a session of one or more authenticated transmission terminals. By causing the transmission terminal to request the relay apparatus via the transmission control apparatus to establish a single point conference session, and causing the relay apparatus to establish the single point conference session, a single-point self-diagnosis of the transmission terminal is performed.

### BACKGROUND OF THE INVENTION

1. Field of the Invention

The disclosures herein generally relate to a technology for transmitting video and audio.

2. Description of the Related Art

A remote conference system, as one form of transmission systems, realizes a state of conducting a real-time conference in which video and audio are collected at each remote conference room, in which there are remote conference participants, by causing pictures of participants to be taken, and spoken words of participants to be collected, by a transmission terminal; by causing the collected video and audio to be transformed into digital data and transmitted to a transmission terminal of another party; and by causing the video to be displayed on the display screen and causing the audio to be output from the speaker in the conference room of the other party.

In this kind of remote conference system, a multipoint remote conference is realized by causing all participating transmission terminals and a video distribution server to be connected, and by causing the distribution of video data and audio data to each transmission terminal to be controlled by the video distribution server.

This kind of remote conference system is expected to operate normally, but sometimes an error occurs because of various reasons.

Content of this kind of an error of a transmission terminal, in general, is that the video data and the audio data are not transmitted properly. As a reason for the error, a hardware error of the transmission terminal itself, an error in a network transmission path between the transmission terminal and the video distribution server, a sufficient network band for conducting a remote conference not being secured, etc., can be considered.

There are various ways to diagnose these errors of the transmission terminal such as: a user prepares another transmission terminal, performs communications between the two transmission terminals and checks the communication state; the user checks the error content of the transmission terminal by using its own self-diagnosis function; a service person visits the user for studying whether the transmission terminal is faulty or not; in the case where the study is not successful at the site, the transmission terminal is brought to the manufacturer and analyzed by a special tool.

In Patent Document 1, a method of self-diagnosis without connecting a measurement tool by switching a video switching apparatus placed between a video conference terminal and switching equipment into a self-diagnosis mode is disclosed.
[Patent Document 1] Japanese Patent Application Publication No. H10-191297

### SUMMARY OF THE INVENTION

There are following problems in the above diagnoses.

(1) In the case where a diagnosis is performed by checking the state of communications between the two transmission terminals, the state of transmission and reception of video data and audio data can be checked, but this case requires preparing two transmission terminals, which is not realistic.

By causing video data and audio data to be loop-backed internally in the transmission terminal (by connecting output signals to input signals internally) by using the self-diagnosis function of the transmission terminal, whether the transmission terminal is internally faulty or not can be checked, but a problem in the transmission path between the video distribution server and the transmission terminal or influence of the network band cannot be checked. In Patent Document 1, the loop-back is performed by the video-switching apparatus that is placed in the subsequent stage of the video conference terminal, and so, the same as the internally performed loop-back, a problem of the transmission path or influence of the network band cannot be checked.

It is a general object of at least one embodiment of the present invention to provide a system in which a single transmission terminal can perform a wide-coverage self-diagnosis covering a transmission path and a network band.

In one embodiment, a transmission terminal configured to reproduce video and audio locally and to transmit and receive video and audio via a network; a relay apparatus configured to distribute the video data and the audio data transmitted by the transmission terminal to other transmission terminals or to the transmission terminal that is a transmission source; and a transmission control apparatus configured to control a session of a plurality of authenticated transmission terminals or a singularity of authenticated transmission terminals are included. The transmission terminal requests the relay apparatus via the transmission control apparatus for a session establishment of a single-point conference; the relay apparatus, upon receiving the request for the session establishment of the single-point conference, establishes a session of a single-point conference for the transmission terminal of the request source. Thus, a self-diagnosis of the transmission terminal becomes possible.

According to the present embodiment, a single transmission terminal can perform a wide-coverage self-diagnosis covering a transmission path and a network band.

### BRIEF DESCRIPTION OF THE DRAWINGS

Other objects and further features of embodiments will become apparent from the following detailed description when read in conjunction with the accompanying drawings.

FIG. 1 is a drawing illustrating an example of a configuration of a transmission system.

FIG. 2 is a drawing illustrating a hardware configuration of a transmission terminal.

FIG. 3 is a drawing illustrating examples of functional configurations of main apparatuses.

FIG. 4 is a flowchart illustrating an example of a process of an automatic selection of a maintenance program.

FIG. 5 is a sequence chart illustrating an example of an authentication process by a SIM card at a start-up of the transmission terminal.

FIG. 6 is a flowchart illustrating an example of a self-diagnosis process by a maintenance program.

FIG. 7 is a drawing illustrating an example of a screen display at the time of the self-diagnosis process.

FIG. 8 is a sequence chart illustrating an example of processes of a session establishment and a loop-back of video and audio for the self-diagnosis process.

### DESCRIPTION OF THE PREFERRED EMBODIMENTS

In the following, embodiments of the present invention will be described with reference to the accompanying drawings.

<Configuration>

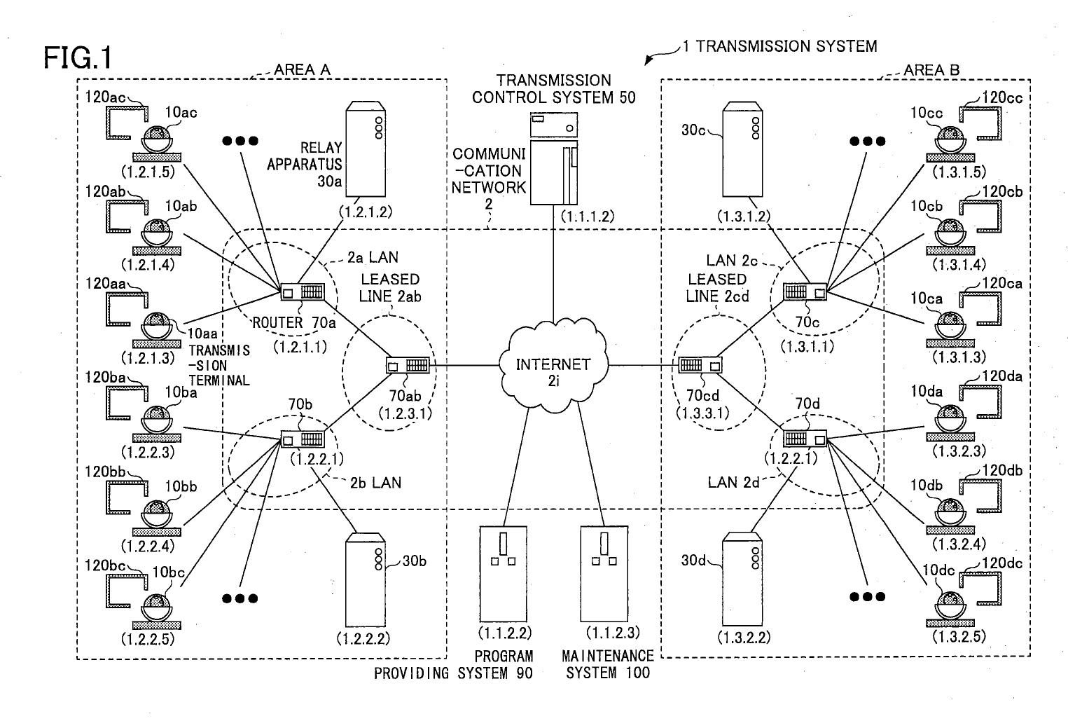

FIG. 1 is a drawing illustrating an example of a configuration of a transmission system 1.

In FIG. 1, the transmission system 1 is configured to include a plurality of transmission terminals 10 (10aa, 10ab, . . . ), displays 120 (120aa, 120ab, . . . ) for the transmission terminals 10, a plurality of relay apparatuses 30 (30a, 30b, 30c, and 30d), a transmission control system 50, a program providing system 90, and a maintenance system 100.

The transmission system 1 can perform transmission and reception of video data by using a video coding standard such as H.264/SVC (Scalable Video Coding), etc. Furthermore, through the transmission control system 50, a control information session for transmission and reception of various kinds of control information is established, and through the relay apparatus 30, video data and audio data are transmitted and received among the transmission terminals 10. Regarding the video coding standard, it is not limited to H.264/SVC, and any standard known to public can be applied. For example, H.264/AVC can be included.

The program providing system 90 includes a storage device such as an HD (Hard Disk), etc, in which terminal programs for causing the transmission terminals 10 to perform various functions (or causing the transmission terminals 10 to function as various kinds of units) are stored, and is capable of transmitting the terminal programs to the transmission terminals 10. Also, in the program providing system 90, relay apparatus programs for causing the relay apparatuses 30 to perform various functions (or causing the relay apparatuses 30 to function as various kinds of units) are stored, and it is capable of transmitting the relay apparatus programs to the relay apparatuses 30. Furthermore, in the program providing system 90, maintenance programs for the transmission terminals 10 are also stored, and it is capable of transmitting the maintenance programs to the transmission terminals 10.

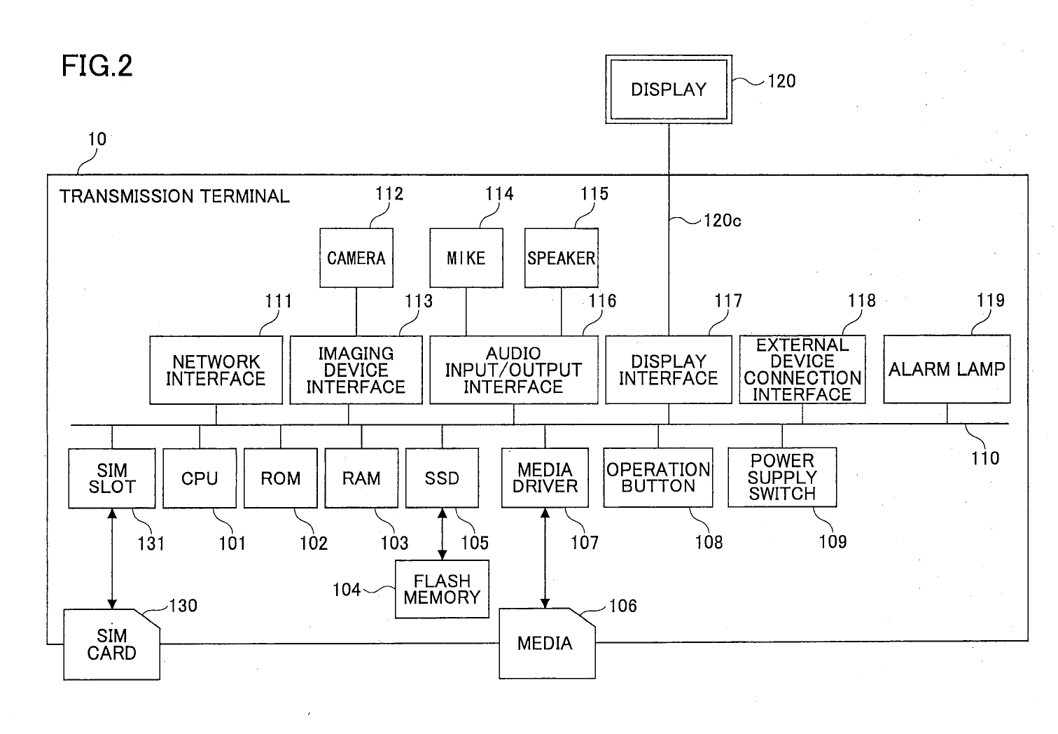

FIG. 2 is a drawing illustrating a hardware configuration of the transmission terminal 10.

The transmission terminal 10 includes a CPU (Central Processing Unit) 101 for controlling overall operations of the transmission terminal 10, a ROM (Read-Only Memory) 102 for storing programs such as IPL (Initial Program Loader), etc., for driving the CPU 101, a RAM (Random Access Memory) 103 for being used for a work area of the CPU 101, a flash memory 104 for storing various kinds of data such as the terminal programs, video data, audio data, etc., and an SSD (Solid State Drive) 105 for controlling reading or writing of various kinds of data to or from the flash memory 104 according to the control of the CPU 101.

Also, the transmission terminal 10 includes a media drive 107 for controlling reading or writing (storing) data to or from recording media 106 such as a flash memory, etc., and a SIM slot 131 for accessing a SIM (Subscriber Identity Module) card 130 in which authentication information, etc., are stored.

Also, the transmission terminal 10 includes an operation button 108 for being operated when a destination of the transmission terminal 10 is selected, a power supply switch 109 for switching ON and OFF of a power supply of the transmission terminal 10, and a network interface 111 for performing data transmission using a communication network 2.

Also, the transmission terminal 10 includes a built-in camera 112 for taking pictures of objects and obtaining video data according to the control of the CPU 101, an imaging device interface 113 for controlling driving of the camera 112, a built-in mike 114 for inputting audio, a built-in speaker 115 for outputting audio, and an audio input/output interface 116 for processing input/output of audio signals with the mike 114 and the speaker 115 according to the control of the CPU 101. The camera 112 includes a lens and a solid-state image sensing device for transforming light into an electrical charge and digitizing a picture (image) of an object. As the solid-state image sensing device, a CMOS (Complementary Metal-Oxide Semiconductor), a CCD (Charge Coupled Device), etc., are used.

Also, the transmission terminal 10 includes a display interface 117 for transmitting video data to an external display 120 according to the control of the CPU 101. The display 120 is a display unit configured to be made of liquid crystal or organic electroluminescence for displaying an image of an object, an operational icon, etc. Also, the display 120 is connected to the display interface 117 via a cable 120c. This cable 120c may be a cable for analog RGB (VGA) signals, a cable for component video, or a cable for HDMI (High-Definition Multimedia Interface) or DVI (Digital Video Interactive) signals.

Also, the transmission terminal 10 includes an external device connection interface 118 for connecting various external devices, an alarm lamp 119 for indicating abnormalities of various functions of the transmission terminal 10, and a bus line 110, such as an address bus, a data bus, etc., for electrically connecting the above components. To the external device connection interface 118, external devices such as an external camera, an external mike, an external speaker, etc., can be electrically connected via a USB (Universal Serial Bus) cable, etc. In the case where an external camera is connected, according to the control of the CPU 101, the external camera is driven in preference to the built-in camera. Likewise, in the case where an external mike is connected, or in the case where an external speaker is connected, according to the control of the CPU 101, the external mike or the external speaker is driven in preference to the built-in mike 114 or the built-in speaker 115.

Note that the transmission terminal 10 may be a PC, a smart phone, a tablet terminal, or a mobile phone. Also, the transmission terminal 10 may not necessarily need to include a built-in camera, a built-in mike, or a built-in speaker but may only include an external camera, an external mike, or an external speaker.

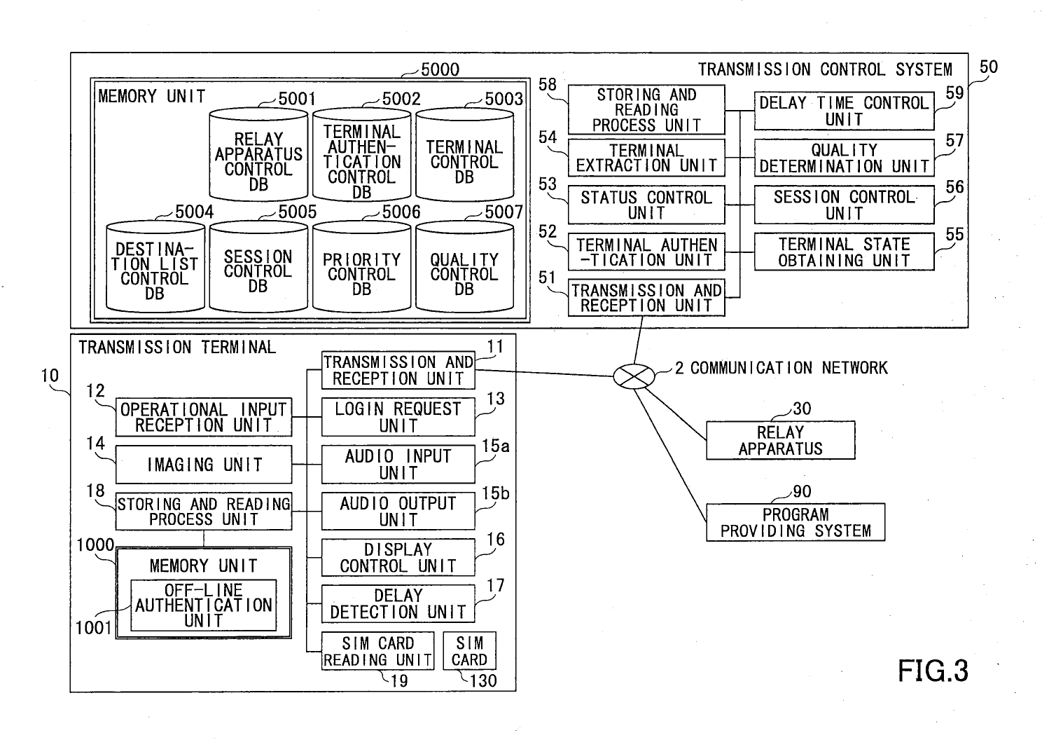

FIG. 3 is a drawing illustrating examples of functional configurations of main apparatuses.

In FIG. 3, the transmission terminal 10 includes a transmission and reception unit 11, an operational input reception unit 12, a login request unit 13, an imaging unit 14, an audio input unit 15a, an audio output unit 15b, a display control unit 16, a delay detection unit 17, a storing and reading process unit 18, a SIM card reading unit 19 and a memory unit 1000. In the memory unit 1000, an off-line authentication unit 1001 is included.

The transmission and reception unit 11 is implemented by the network interface 111 shown in FIG. 2 and performs transmission and reception of various data (information) with other terminals, apparatuses or systems via a communication network 2.

The operational input reception unit 12 is implemented by the operation button 108 and the power supply switch 109 shown in FIG. 2, and accepts various inputs from a user.

The login request unit 13 is implemented by the CPU 101 shown in FIG. 2, and upon reception of a power supply ON, automatically causes login request information indicating a login request and a current IP address of the transmission terminal 10 as a request source (request source terminal) to be transmitted from the transmission and reception unit 11 to the transmission control system 50 via the communication network 2.

The imaging unit 14 is implemented by the camera 112 and the imaging device interface 113 shown in FIG. 2, and takes pictures of objects using the camera 112 and outputs the data of the taken pictures.

The audio input unit 15a is implemented by the mike 114 and the audio input/output interface 116 shown in FIG. 2, after causing user's audio to be transformed to audio signals by the mike 114, inputs the data of the audio signals.

The audio output unit 15b is implemented by the audio input/output interface 116 and the speaker 115 shown in FIG. 2 and outputs audio by outputting audio signals from the speaker 115.

The display control unit 16 is implemented by the display interface 117 shown in FIG. 2 and performs controlling of transmission of video data to the external display 120.

The delay detection unit 17 is implemented by the CPU 101 shown in FIG. 2 and detects the delayed time (ms) of the video data or the audio data transmitted from other transmission terminals 10 via the relay apparatus 30.

The storing and reading process unit 18 is implemented by the SSD 105, etc., and performs processes of storing various data in the memory unit 1000 implemented by the flash memory 104, and of reading various data stored in the memory unit 1000.

The SIM card reading unit 19 is implemented by the SIM slot 131, etc., shown in FIG. 2 and performs reading information from the SIM card 130. In the SIM card 130, client information is stored for the transmission terminal 10 to perform authentication and is only accessible via the SIM card reading unit 19.

The off-line authentication unit 1001 performs a terminal authentication using the client authentication information stored in the SIM card 130 when the transmission terminal 10 is not connected to the network. In the case where the transmission terminal 10 is connected to the network, the transmission terminal 10, using the information stored in the SIM card 130, via the communication network 2, performs an authentication with the transmission control system 50. In this case, in the transmission control system 50, a terminal authentication unit 52, which will be described later, performs the terminal authentication using a terminal authentication control DB 5002.

The transmission control system 50 includes a transmission and reception unit 51, the terminal authentication unit 52, a status control unit 53, a terminal extraction unit 54, terminal state obtaining unit 55, a session control unit 56, a quality determination unit 57, a memory read process unit 58, a delay time control unit 59 and a memory unit 5000. In the memory unit 5000, a relay apparatus control DB (Data base) 5001, a terminal authentication control unit DB 5002, a terminal control DB 5003, a destination list control DB 5004, a session control DB 5005, a priority control DB 5006 and a quality control DB 5007 are included.

The transmission and reception unit 51 performs transmission and reception of various data (or information) with other terminals, apparatuses or systems via the communication network 2.

the terminal authentication unit 52 performs a terminal authentication by searching the terminal authentication control DB 5002 of the memory unit 5000, using a terminal ID and a password included in the login request information received via the transmission and reception unit 51 as searching keys and by determining whether the same terminal ID and the password are maintained in a terminal authentication control table. Note that instead of the password authentication, a more complicated authentication method can be used.

The status control unit 53, in order to control operation statuses of login request source terminals, in a terminal control table of the terminal control. DB 5003, stores a terminal ID of the request source terminal, an operation status of the request source terminal, a reception date and time at which the login request information is received by the transmission control system 50 associated with an IP address of the request source terminal, and maintains the table.

The terminal extraction unit 54, using the terminal ID of the request source terminal as a search key, searches the destination list control table of the destination list control DB 5004 for terminal IDs of destination terminal candidates that can communicate with the request source terminal, reads and extracts the terminal IDs.

The terminal state obtaining unit 55, using the terminal IDs of destination terminal candidates extracted by the terminal extraction unit 54 as search keys, searches the terminal control table of the terminal control DB 5003, and reads corresponding operation states of the terminal IDs extracted by the terminal extraction unit 54.

The session control unit 56, in the session control table of the session control DB 5005, stores a session ID and a request source terminal ID associated with the terminal IDs of the destination terminals, and maintains the table.

The quality determination unit 57, using the delayed time as a search key, searches the quality control table of the quality control DB 5007, determines an image quality of the video data to be relayed by the relay apparatus 30 by extracting the corresponding image quality of the video data.

The memory read process unit 58 performs processes of storing various data in the memory unit 5000 and reading the various data stored in the memory unit 5000.

The delay time control unit 59, by searching the terminal control table of the terminal control DB 5003 using an IP address of the destination terminal as a search key, extracts the corresponding terminal ID, and, furthermore, in the session control table of the session control DB 5005, in a field of the delayed time of a record in which the extracted terminal ID is included, stores the delayed time indicated by the delayed information, and maintains the table.

<Operations>

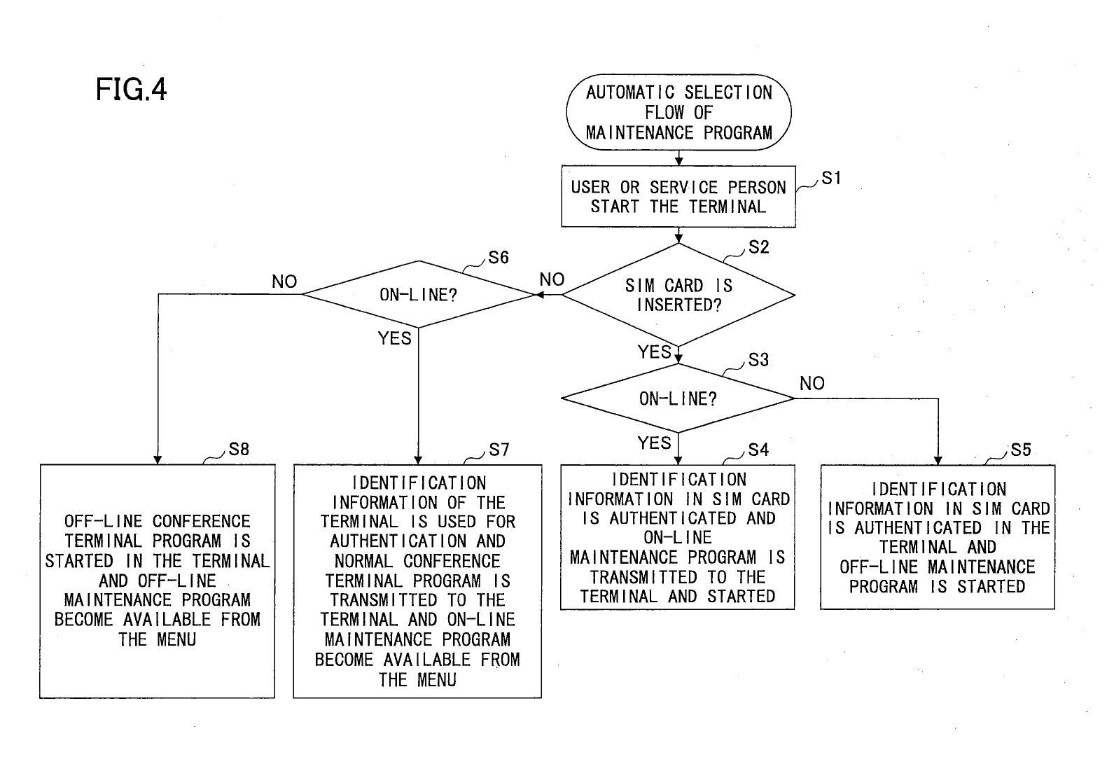

FIG. 4 is a flowchart illustrating an example of a process of automatic selection of a maintenance program.

In FIG. 4, a user or a service person starts the transmission terminal 10 (step S1). At this time, if it is a service person, a SIM card 130 for maintenance is inserted into the transmission terminal 10 and the transmission terminal 10 is started. Regarding the operation of the SIM card 130 for maintenance, it should be under a strict control in which, for example, only a service person who gets a permission beforehand can carry the SIM card 130.

The transmission terminal 10, after the start-up, determines whether the SIM card 130 is installed (inserted) or not (step S2).

In the case where the SIM card 130 is installed (YES for step S3), the transmission terminal 10 determines whether the state is an on-line in which connection to the communication network 2 is available (step S3).

In the case where the state is an on-line (YES for step S3), a terminal authentication is performed in the terminal authentication unit 52 of the transmission control system 50, and if the authentication is successful, an on-line maintenance program is transmitted from a program providing system 90 to the transmission terminal 10 and is started at the transmission terminal 10 (step S4).

In this case of terminal authentication, identification information stored in the SIM card 130 is used. This identification information is the one maintained in the transmission control system 50 and indicates terminal identification information. Note that, instead of the terminal identification information, user identification information may be used. Note that in the case where the SIM card 130 is lost, the SIM card 130 can be remotely disabled by eliminating the corresponding authentication information from the terminal authentication control DB 5002 in the transmission control system 50.

Also, the on-line maintenance program is a program that is not related to a normal conference, is not guaranteed for use by an ordinary user, and is related to updating firmware or BIOS, obtaining network communication quality information from the transmission control system 50, accommodating non-compliant devices, etc.

In the case where the state is an off-line (NO for step S3), the identification information in the SIM card 130 is authenticated in the off-line authentication unit 1001 of the transmission terminal 10, and if the authentication is successful, the off-line maintenance program is started (step S5).

The off-line maintenance program is a program related to functions, which can be performed with a lower authentication level compared to the on-line maintenance program, such as functions of obtaining log data of the transmission terminal 10 during its operation, obtaining network configuration information, etc. Also, the off-line maintenance program is stored in the memory unit of the SIM card 130 or the memory unit of the transmission terminal 10.

On the other hand, in the case where the SIM card 130 is not installed (NO for step S2), the transmission terminal 10 determines whether the state is an on-line in which connection to the communication network 2 is available (step S6).

In the case where the state is an on-line (YES for step S6), a terminal authentication is performed in the terminal authentication unit 52 of the transmission control system 50 using identification information obtained from the transmission terminal 10, if the authentication is successful, then the transmission terminal 10 is started in a mode for an ordinary user (step S7). That is, an ordinary conference terminal program is transmitted to the transmission terminal 10 and started, and an on-line maintenance program for an ordinary user becomes available from the menu.

In the case where the state is an off-line (NO for step S6), in the transmission terminal 10, an off-line conference terminal program is started, and an off-line maintenance program for an ordinary user becomes available from the menu (step S8).

Conventionally, after an authentication, only UI (User Interface) information or configuration information is obtained from a server, and an operation setting or a UI of the transmission terminal is changed. In this case, a maintenance process program itself is stored in the transmission terminal, in which program, functions of identifying a trouble is included and some of the functions are allowed to be used only by a service person because of a security reason or a quality assurance reason. There is a risk that these functions are used by an ordinary user because they are installed the same as other conference functions. For example, because there is a risk that the disk of the transmission terminal is taken out and analyzed by a reverse assembler and the maintenance information is revealed, the encryption of the disk is needed in order to avoid such a risk.

In the present embodiment, maintenance functions can be provided safely by having maintenance process program itself either placed in a server (cloud) or stored in an authentication disk (e.g., SD card type SIM card), and having the maintenance process program installed in the transmission terminal after the successful authentication.

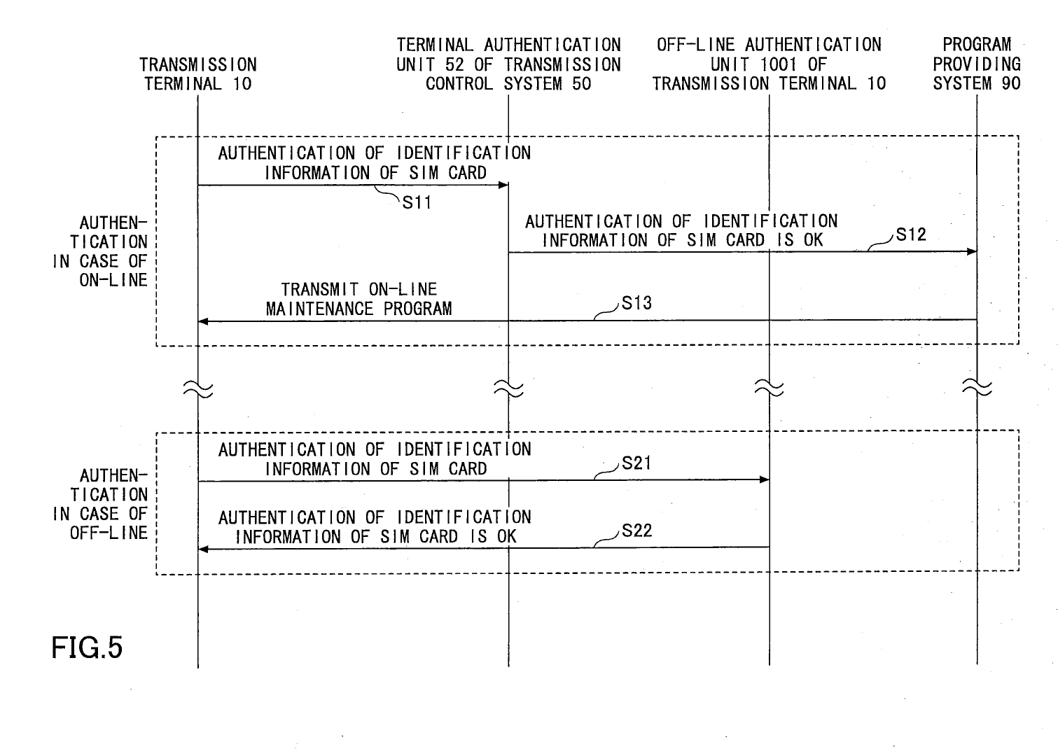

FIG. 5 is a sequence chart illustrating an example of an authentication process by the SIM card 130 at the start-up of the transmission terminal 10.

In FIG. 5, in the case of an on-line, identification information of the SIM card 130 is transmitted from the transmission terminal 10 to the terminal authentication unit 52 of the transmission control system 50 (step S11). After the successful authentication, the same is transmitted from the transmission control system 50 to the program providing system 90 (step S12), and the on-line maintenance program is transmitted from the program providing system 90 to the transmission terminal 10 (step S13).

In the case of an off-line, in the transmission terminal 10, identification information of the SIM card 130 is transmitted to the off-line authentication unit 1001 (step S21), and after the successful authentication, the same is returned from the off-line authentication unit 1001 (step S22).

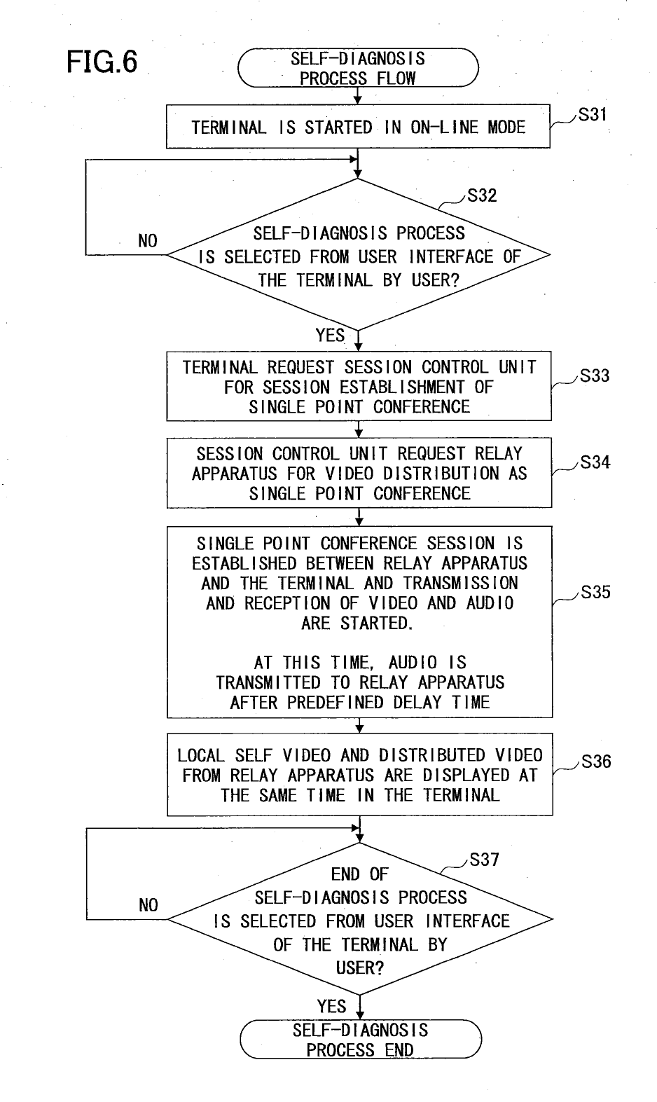

FIG. 6 is a flowchart illustrating an example of a self-diagnosis process by the maintenance program. Note that it is prerequisite for this flowchart to be executed that the transmission terminal 10 is started in an on-line mode.

In FIG. 6, when the transmission terminal 10 is started in an on-line mode (step S31), the transmission terminal 10 waits in a standby mode until the self-diagnosis process is selected and performed from the menu of the user interface (UI) of the transmission terminal 10 (step S32).

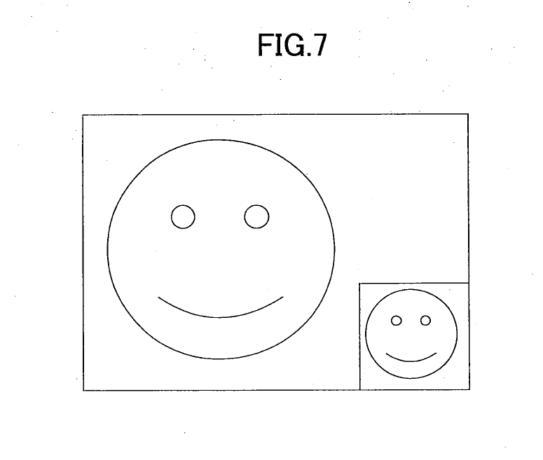

When the self-diagnosis process is performed (YES for step S32), the transmission terminal 10 requests the session control unit 56 in the transmission control system 50 for a session establishment for a single point conference (step S33). The single point conference is a virtual conference room made of a single transmission terminal 10, in which the self video and audio are loop-backed and transmitted back from the relay apparatus 30 to the transmission terminal 10 connected by the single point conference session. FIG. 7 is a drawing illustrating an example of a screen display at this time, in which a local image is displayed in a small area of the lower right, and a loop-backed image is displayed in the remaining big area.

Returned to FIG. 6, the session control unit 56 of the transmission control system 50 requests the relay apparatus 30 for an image distribution as a single point conference (step S34). After that, the single point conference session is established between the relay apparatus 30 and the transmission terminal 10, and transmission and reception of video and audio are started (step S35). At this time, while regarding the video, the self video is loop-backed in real time from the relay apparatus 30, regarding the audio, for the sake of easy diagnosis, the self audio is recorded and after a delay of, for example, about three seconds, transmitted to the relay apparatus.

In the transmission terminal 10, the local self video without going through the relay apparatus and the video distributed by the relay apparatus 30 are displayed at the same time, and the audio input from the mike is loop-backed by the relay apparatus 30 and reproduced by the speaker (step S36). By this, diagnoses of functions of the camera, the mike and the speaker can be performed using a single transmission terminal 10. Also, whether there is a problem in the network between the transmission terminal 10 and the relay apparatus 30 can be determined.

After that, by having the user selecting and performing the end of the self-diagnosis from the menu of the user interface of the transmission terminal 10 (YES for step S37), the self-diagnosis ends.

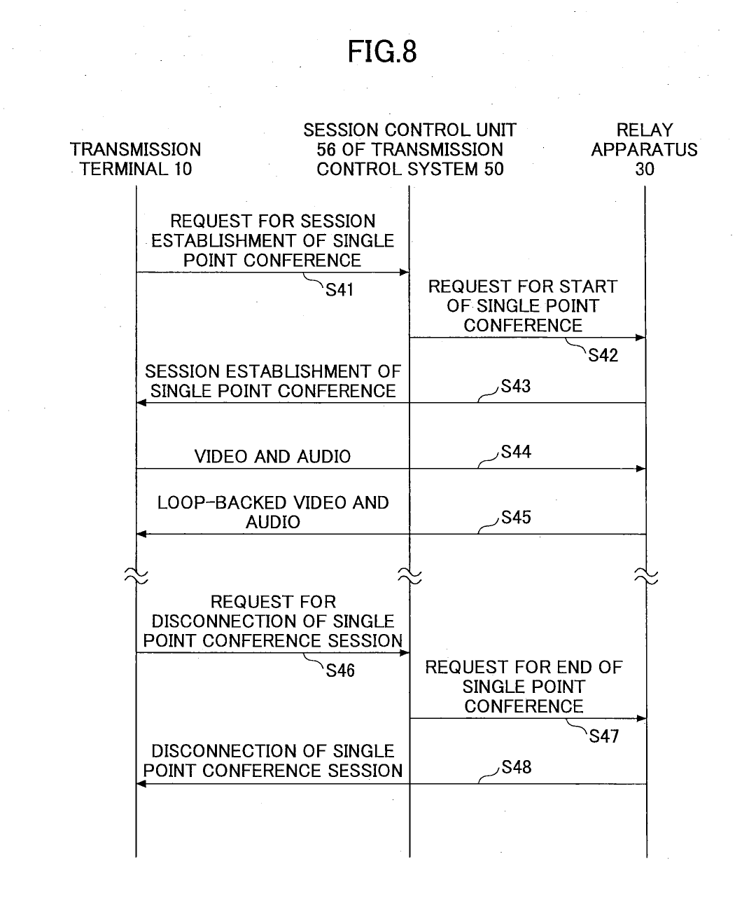

FIG. 8 is a sequence chart illustrating an example of processes of the session establishment and the loop-back of video and audio for the self-diagnosis process.

In FIG. 8, when the establishment of the single point conference session is requested to the session control unit 56 of the transmission control system 50 by the transmission terminal 10 (step S41), the session control unit 56 requests the relay apparatus 30 to start the single point conference (step S42), and the relay apparatus 30 notifies the transmission terminal 10 of the session establishment of the single point conference (step S43).

The transmission terminal 10 transmits the video and audio to the relay apparatus 30 (step S44), and the relay apparatus 30 loop-backs and transmits them back to the transmission terminal 10 (step S45).

Later, when the transmission terminal 10 requests the session control unit 56 of the transmission control system 50 for disconnection of the single point conference session (step S46), the session control unit 56 requests the relay apparatus 30 for ending the single point conference (step S47) and the relay apparatus 30 notifies the transmission terminal 10 of the disconnection of the single point conference session (step S48).

Conventionally, video and audio were loop-backed and checked in the inside of the transmission terminal, or a self-diagnosis was performed using a switching apparatus placed in front of switching equipment, and there was no self-diagnosis function in which a trouble in the transmission path between the video distribution server and the transmission terminals or a network band was taken into account.

In the present embodiment, a self-diagnosis in which an effect of the transmission path is taken into account is possible.

### CONCLUSION

As described above, according to the present embodiment, there are following merits.

(1) During the self-diagnosis mode, by having the video data and the audio data loop-backed by the video distribution server and transmitted to the transmission terminal, the self-diagnosis can be performed in the same network configuration as the real conference configuration. By having both the “local image”, which is taken by the camera of the transmission terminal and displayed in the transmission terminal, and the “loop-backed image”, which is distributed from the video distribution server, displayed at the same time and enabled to be compared, a network delay can also be checked. Regarding the audio, by having the audio recorded by the transmission terminal during the diagnosis and by having the recorded audio data reproduced locally and reproduced with a delay via the loop-back, the two reproductions can be compared and an audio degradation can be checked.

(2) Regarding providing a service while ensuring security, a maintenance program is downloaded from a server environment (cloud environment) for processing the service only when an authentication using a SIM card, etc., is successful, thus, the transmission terminal, normally, is made not to have the maintenance program. By this, the security is ensured. In the case where the network cannot be connected, the program is stored in a “SD card for maintenance”, which requires an authentication to be used, and a service person can use the “SD card for maintenance” as a combined card of a SIM card and a maintenance program storing card.

The present invention has been described according to various embodiments.

The present invention is not limited to these embodiments, and various variations and modifications may be made without departing from the scope of the present invention.

The present application is based on and claims the benefit of priority of Japanese Priority Application No. 2012-201143 filed on Sep. 13, 2012, with the Japanese Patent Office, the entire contents of which are hereby incorporated by reference.

What is claimed is:

1. A transmission system comprising:
a transmission terminal configured to locally reproduce, transmit and receive via a network, video and audio,
a relay apparatus configured to distribute the video data and the audio data transmitted from the transmission terminal to other transmission terminals or to the transmission terminal that is a transmission source, and
a transmission control apparatus configured to control a session of one of more authenticated transmission terminals, wherein a single-point self-diagnosis of the transmission terminal is performed by causing the transmission terminal to request the relay apparatus via the transmission control apparatus to establish a single point conference session, and causing the relay apparatus to establish the single point conference session.

2. The transmission system as claimed in claim 1, wherein, during the single point conference, a fault diagnosis of a camera, checking of the image quality and checking of a network delay of the video are performed by causing the transmission terminal to display both a local image and a loop-backed image from the relay apparatus at the same time, and causing the images to be compared.

3. The transmission system as claimed in claim 1, wherein a fault diagnosis of a mike and a speaker, checking of the audio quality and checking of a network delay of the audio are performed by causing the transmission terminal to include functions to record input audio and to transmit the recorded audio at a predefined timing, and causing the distributed audio from the relay apparatus to be checked.

4. The transmission system as claimed in claim 1, further comprising:
an authentication medium configured to store authentication information, and
a program providing apparatus configured to transmit a program to the transmission terminal based on an authentication result by the transmission control apparatus, wherein, in a case where the authentication medium is installed in the transmission terminal, based on the authentication information stored in the authentication medium, authentication is performed by the transmission control apparatus, and in a case where the authentication is successful, a maintenance program is transmitted from the program providing apparatus to the transmission terminal.

5. The transmission system as claimed in claim 4, wherein, in a case where the transmission terminal is off-line, the authentication is performed locally by the transmission terminal, and an off-line-only maintenance program, whose functions are limited compared to an on-line maintenance program, is executed.

6. The transmission system as claimed in claim 5, wherein the off-line-only maintenance program is stored in the transmission terminal.

7. The transmission system as claimed in claim 5, wherein the off-line-only maintenance program is stored in the authentication medium.

8. The transmission system as claimed in claim 4, wherein, by causing the transmission control apparatus to control authentication information corresponding to the authentication information stored in the authentication medium, in a case where the authentication medium is lost, the authentication information of the authentication medium is remotely disabled.

9. A relay apparatus comprising:
a distribution unit configured to distribute video data and audio data transmitted from a transmission terminal, which is configured to locally reproduce and transmit and receive via a network the video and the audio, to other transmission terminals or to the transmission terminal that is a transmission source, and
a session establishment unit configured to, in a case where a request for a single point conference session establishment is received from the transmission terminal via a transmission control apparatus for controlling a session of one or more authenticated transmission terminals, establish the single point conference session for the requesting transmission terminal, wherein a self-diagnosis of the transmission terminal is performed.

10. A transmission method for a single-point transmission terminal self-diagnosis in a transmission system including a transmission terminal configured to locally reproduce, and transmit and receive via a network, video and audio; a relay apparatus configured to distribute the video data and the audio data transmitted from the transmission terminal to other transmission terminals or to the transmission terminal that is a transmission source; and a transmission control apparatus configured to control a session of one of more authenticated transmission terminals, the transmission method comprising:
a step of causing the transmission terminal to request the relay apparatus via the transmission control apparatus to establish a single point conference session, and
a step of causing the relay apparatus to establish the single point conference session.
